(19) United States
(12) Patent Application Publication
(10) Pub. No.: US 2026/0347226 A1
(43) Pub. Date: Nov. 5, 2026

(54) METHOD FOR THE TREATMENT OF COMPLEX WASTE

(71) Applicant: SUEZ INTERNATIONAL, Paris La Défense Cedex (FR)

(72) Inventors: Pierre-Emmanuel PARDO, Paris La Défense Cedex (FR); Safwan AL AYOUBI, Paris La Défense Cedex (FR)

(73) Assignee: SUEZ INTERNATIONAL, Paris La Défense Cedex (FR)

(21) Appl. No.: 18/997,839

(22) PCT Filed: Jul. 28, 2023
(86) PCT No.: PCT/EP2023/071020

§ 371 Date: Jan. 23, 2025

(30) Foreign Application Priority Data
Jul. 29, 2022 (FR) FR2207902

(51) Int. Cl. C02F 11/18; C02F 11/04; C10J 3/78

(52) U.S. Cl. CPC C02F 11/18; C02F 11/04; C10J 3/78; C02F 2303/10; C10J 2300/0923; C10J 2300/0946; C10J 2300/0979; C10J 2300/1681; C10J 2300/169

(57) ABSTRACT

A method for treating a mixture comprising at least organic matter. The method involves hydrolyzing a mixture M1 to obtain a hydrolyzed mixture M1h. At least one fraction is pressurized and then heated to obtain a mixture M2. A fraction of this mixture is separated to obtain a first stream enriched in inorganic matter M3 and a first stream depleted of inorganic matter M4. A fraction of the first stream depleted of inorganic matter M4 is heated and separated to obtain a second stream enriched in inorganic matter M5 and a second stream depleted of inorganic matter M6. Hydrothermal gasification is carried out on at least one fraction of the second stream M6 depleted in inorganic matter to obtain at least one stream M8 comprising gas and a liquid effluent.

### TECHNICAL FIELD OF THE INVENTION

The invention relates to the field of treatment of complex waste comprising organic and inorganic matter, such as wet biomass and bio-waste, in particular industrial food or agri-food waste, and sludge and sludge from wastewater treatment plants.

### STATE OF THE ART

The methods of the state of the art attempt to treat heterogeneous matter, that is, comprising both organic matter and inorganic matter, with a hydrothermal gasification type process.

These hydrothermal gasification-type processes are fraught with pitfalls, particularly when the biological waste (for example wet biomass) is heterogeneous and/or has a high dryness and/or low thermal conductivity. Indeed, this type of process uses heat exchangers, and due to the composition of this biomass, clogging of the exchangers can occur.

Efficient recovery of the inorganic matter present in or resulting from the decomposition of this type of heterogeneous biomass remains a technical and economic challenge in the state of the art of hydrothermal gasification, since this separation is not sufficiently selective to recover the various inorganic components (salts, oxides, metals, etc.) separately. Thereby, any recovery of this inorganic fraction would require numerous post-treatment steps and would be low-yield and economically unviable.

Finally, the methods of the state of the art can generate high heat consumption and can give rise to significant construction costs.

Indeed, when biomass is heterogeneous, with high dryness and low thermal conductivity, this leads to very steep temperature gradients within the biomass matrix at heat exchanger level leading to undesirable reactions (for example, tar formation). Furthermore, low thermal conductivity leads to a significant increase in exchanger surface area, resulting in very high costs.

There is therefore a need to propose a treatment method with a high yield and improved selectivity for the recovery of waste containing organic matter and inorganic matter.

The present invention allows hydrothermal gasification to optimize all of the advantages thereof: transforming complex mixtures containing organic and inorganic solids into recoverable gaseous, liquid and solid products. This is achieved by virtue of interconnecting several treatment and selective recovery steps, while minimizing cost constraints by virtue of perfect homogenization of the input biomass in particular due to a drastic reduction in viscosity.

### SUMMARY OF THE INVENTION

The invention relates to a method for treating a mixture M1 comprising at least organic matter, said method comprising:
a) a step of hydrolyzing mixture M1 at a temperature ranging from 70 to 165 °C and at a pressure ranging from 2 to 8 bar, making it possible to obtain a hydrolyzed mixture M1h,
b) pressurizing at least one fraction of the hydrolyzed mixture M1h,
c) a step of heating mixture M1h from step b) in order to obtain a mixture M2,
d) a first step of separating at least one fraction of the mixture M2 from step c) in order to obtain a first stream enriched in inorganic matter M3 and a first stream depleted of inorganic matter M4,
e) a heating step carried out on at least one fraction of the first stream depleted of inorganic matter M4,
f) a second step of separating at least one fraction of the first stream depleted of inorganic matter M4 from step e) in order to obtain a second stream enriched in inorganic matter M5 and a second stream depleted of inorganic matter M6,
g) a hydrothermal gasification step carried out on at least one fraction of the second stream M6 depleted in inorganic matter in order to obtain at least one stream M8 comprising gas and a liquid effluent.

According to one embodiment of the method of the invention, the pressurization step b) raises the pressure of the hydrolyzed mixture M1h to a pressure of 150 to 300 bar and/or the heating step c) heats the mixture M1h resulting from step b) to a temperature ranging from 200 to 350 °C.

According to one embodiment of the method of the invention, heating step e) heats all or part of the first stream depleted of inorganic matter M4 at a temperature ranging from 300 °C to less than 600 °C.

According to one embodiment of the method of the invention, the pressurization step b) brings the hydrolyzed mixture M1h to a pressure ranging from 150 to 220 bar, said method further comprising pressurization of the first stream depleted of inorganic matter M4 from step d), implemented upstream of the heating in step e).

Preferably, the first stream depleted of inorganic matter M4 from step d) is raised to a pressure greater than or equal to 225 bar in order to obtain a stream M4′ and heating step e) heats stream M4′ to a temperature ranging from 400 °C to less than 600 °C.

According to one embodiment of the method of the invention, the gasification step comprises a separation step making it possible to obtain a stream enriched in inorganic matter M7 and stream M8.

According to one embodiment, the method of the invention further comprises at least one step of recovering at least one fraction of the inorganic matter in the form of salts, said recovery step being implemented on at least one fraction of a stream selected from:
the first stream enriched in inorganic matter M3 and
the second stream enriched in inorganic matter M5
stream M7 enriched in inorganic matter.

According to one embodiment of the method of the invention, mixture M1 comprises from 5 to 50% by weight of solids, preferably from 15 to 25% by weight of solids, with respect to the total weight of mixture M1.

According to one embodiment of the method of the invention, the first stream enriched in inorganic matter M3 from step d) comprises silica, preferably in a proportion ranging from 10 to 30% by weight, with respect to the total dry weight of the first stream enriched in inorganic matter M3.

According to one embodiment of the method of the invention, the second stream of inorganic matter M5 from step f) comprises phosphorus, preferably in a proportion ranging from 1 to 20% by weight, with respect to the total dry weight of the stream enriched in inorganic matter M5.

According to one embodiment of the method of the invention, at least one additive is added, said additive preferably being added to at least one fraction of a stream selected from:
The stream of mixture M1 upstream of step a),
The stream of mixture M1h upstream of step c),
the stream of mixture M2 from step c),
the first stream enriched in inorganic matter M3,
the second stream enriched in inorganic matter M5,
stream M7 enriched in inorganic matter.

Preferably, at least a first additive is added to the first stream enriched in inorganic matter M3 from step d) and at least a second additive is added to the second stream enriched in inorganic matter M5 from step f), the first additive preferably being different from the second additive.

According to one embodiment of the invention, the method further comprises a step of recovering heat present in stream M8 from the hydrothermal gasification, said recovered heat is preferably used to at least partially heat mixture M1h during heating step c).

According to one embodiment of the invention, the method further comprises at least one digestion step carried out on at least one fraction of a liquid effluent M10 obtained by cooling and then expanding at least one fraction of stream M8 from step g).

The invention also relates to an installation for implementing the treatment method according to the invention, said installation comprising:
one or more hydrolysis reactors 1 optionally comprising a stirring device, supplied at the inlet by a feed line for mixture M1 to be treated and comprising an outlet line for the hydrolyzed mixture,
optionally, a mechanical grinding device supplied by the outlet line for the hydrolyzed mixture and comprising an outlet line for the hydrolyzed and ground mixture,
a pressurization pump (3) supplied at the inlet by the hydrolyzed mixture, which is optionally ground,
a heating device 4 comprising an inlet for introducing at least one fraction of the pressurized mixture downstream of the pump 3,
a first separation device 51 supplied with at least one fraction of the heated mixture from the heating device 4 and comprising an outlet for a stream M3 enriched in inorganic matter and an outlet for a stream M4 depleted of inorganic matter,
optionally, a pressurization pump (61) supplied by at least one fraction of stream M4 depleted of inorganic matter, making it possible to obtain stream M4′,
a heating device 6 supplied by stream M4 depleted of inorganic matter from the separation device 51 or by stream M4′ depleted of inorganic matter from the pressurization pump 61 when it is present,
a second separation device 71 supplied with at least one fraction of the heated mixture from the heating device 6 and comprising an outlet for a stream M5 enriched in inorganic matter and an outlet for a stream M6 depleted of inorganic matter,
a hydrothermal gasification reactor 8 supplied with at least one fraction of stream M6 depleted of inorganic matter.

The invention makes it possible to improve the treatment of organic matter in a complex wet matrix such as wet biomass and bio-waste, in particular industrial, food or agri-food waste, and sludge and sludge from wastewater treatment plants.

Improved treatment allows better recovery on the one hand of inorganic matter, such as salts, metals and on the other hand of organic matter.

### BRIEF DESCRIPTION OF THE FIGURES

FIG. 1 is a schematic representation of a treatment method according to the invention.

FIG. 2 is a schematic representation of a treatment method according to the invention.

FIG. 3 is a schematic representation of a treatment method according to the invention.

FIG. 4 is a schematic representation of a treatment method according to the invention.

### DETAILED DESCRIPTION OF THE INVENTION

The invention relates to a method for treating a mixture M1 comprising at least organic matter, said method comprising:
a. a step of hydrolyzing mixture M1 at a temperature ranging from 70 to 165 °C and at a pressure ranging from 2 to 8 bar making it possible to obtain a hydrolyzed mixture M1h,
b. pressurizing at least one fraction of the hydrolyzed mixture M1h, preferably all of the hydrolyzed mixture M1h,
c. a step of heating mixture M1h from step b) in order to obtain a mixture M2,
d. a first step of separating at least one fraction of the mixture M2—preferably all of mixture M2—from step c) in order to obtain a first stream enriched in inorganic matter M3 and a first stream depleted of inorganic matter M4,
e. a heating step carried out on at least one fraction of the first stream depleted of inorganic matter M4, preferably on all of the first stream depleted of inorganic matter M4,
f. a second step for separating at least one fraction of the first stream depleted of inorganic matter M4—preferably all of the first stream M4—from step e) in order to obtain a second stream enriched in inorganic matter M5 and a second stream depleted of inorganic matter M6,
g. a hydrothermal gasification step carried out on at least one fraction of the second stream depleted of inorganic matter M6, preferably on all of the second stream depleted of inorganic matter M6, in order to obtain a gas and a liquid effluent.

For the purposes of the present invention, the expression “at least one fraction of a mixture or stream” has the same meaning as the expression “all or part of said mixture or stream”. In the case of a part of said mixture or of said stream, this expression refers to a certain proportion of said mixture or said stream. For example, for the purposes of this expression, “each fraction of the mixture” or “each fraction of the stream” will have the same composition.

Thus, for the purposes of the present invention, the expression “step X carried out on all of stream M from step Y” means that steps X and Y are successive and that there is no intermediate separation step between steps X and Y, it being understood that there could be cooling/heating of stream M between steps X and Y, in particular by heat exchange which could optionally involve an exchange of streams.

### Mixture M1 Comprising at Least Organic Matter

Mixture M1 comprises at least organic matter. Typically, mixture M1 further comprises inorganic matter. Inorganic matter includes salts comprising anions such as phosphates, sulfates, chlorides, carbonates and hydrocarbonates with counterions such as sodium, magnesium, calcium, ammonium and metals.

Mixture M1 may for example be selected from primary, mixed or biological sludge from municipal and industrial wastewater treatment plants.

According to one embodiment, mixture M1 comprises from 5 to 50% by weight of solids, preferably from 15 to 25% by weight of solids, with respect to the total weight of mixture M1.

### Hydrolysis Step a)

The method according to the invention comprises a hydrolysis step of mixture M1.

The hydrolysis step is carried out at a temperature ranging from 70 to 165 °C and at a pressure ranging from 2 to 8 bar. These conditions prevent the medium from vaporizing.

According to one embodiment, the temperature during hydrolysis step a) ranges from 100 to 165 °C, or even 140 to 165 °C.

The hydrolysis step reduces the viscosity of the mixture. Thus, step a) allows a mixture M1h also known as hydrolysate to be obtained.

The hydrolysis step allows the organic matter to be broken down, in particular by breaking the chemical bonds and depolymerizing the organic matter through the effect of water.

Mixture M1h will typically have a viscosity at least 2 times lower, preferably at least 4 times lower, even more preferably at least 10 times lower than the viscosity of mixture M1.

Thus, the ratio between the viscosity of mixture M1 and the viscosity of mixture M1h is at least 2, preferably at least 4, even more preferably at least 10.

The viscosity defined in the context of the present invention is a kinematic viscosity that can be measured at the same temperature (for example 20 °C) using rheometers adapted to the viscosity to be measured (cylinder-cylinder, plane-plane) and by measuring the two viscosities at the same shear rate (in s⁻¹), typically taking care to eliminate turbulence problems and to comply with rheological rules (for example, spacing between cylinders based on particle size).

The hydrolysis step carried out on mixture M1 can be carried out in one or more hydrolysis reactors in parallel or in series.

Said hydrolysis step allows mixture M1 to be hydrolyzed notably by maintaining an average hydraulic residence time at the desired temperatures and pressures (in the method of the invention, at temperatures ranging from 70 to 165 °C and pressures ranging from 2 to 8 bar), it being understood that if the hydrolysis step is carried out in several hydrolysis reactors, the temperature may be identical or different in the different reactors, and similarly, the pressure may be identical or different in the different reactors.

Advantageously, the hydrolysis step will carry out an internal energy recovery step, thus minimizing the heat consumption of hydrolysis. For example, there could be an energy recirculation loop from the hot hydrolysate to the cold product to be hydrolyzed, for example, by production of steam for expansion of the hot hydrolysate and injection into the cold product to be hydrolyzed or heat exchange.

At the end of the hydrolysis step, a hydrolysate M1h is obtained, which is not necessarily at the desired temperatures and pressures for hydrolysis. Indeed, before the end of the hydrolysis step, the hydrolysate may optionally undergo a cooling and/or expansion step.

In particular, for example if hydrolysis is carried out at a high temperature, for example ranging from 100 to 165 °C, then it may be desirable to cool the hydrolysate to a temperature below 90 °C for example, so that stream M1h has a lower temperature for pressurization in step b) of the method of the invention Extraction of the hydrolysate M1h can be controlled by measuring viscosity.

According to one embodiment, at least one additive is added:
to mixture M1 to be treated prior to entry into the hydrolysis device and/or
to the mixture during hydrolysis and/or
to mixture M1h downstream of hydrolysis.

According to one embodiment, the additive(s) are selected from alkaline reagents such as, for example, KOH, NaOH, KHCO3, K2CO3, CaO, Ca(OH)2, CaCO3, Ca(HCO3)2, Mg(OH)2, MgO.

According to one embodiment, a controlled amount of steam can be injected into the hydrolysis reactor(s) and diffused through mixture M1. This control can be carried out by measuring the temperature in the hydrolysis reactor. Once the setpoint temperature has been reached, steam injection can be stopped.

Steam can be injected:
upstream of hydrolysis into the inlet with a dynamic mixer type mixer, and/or
directly in the hydrolysis reactor, preferentially in the lower part in a tangential manner to avoid clogging by sludge, and/or
in a hydrolyzed sludge recirculation loop.

According to one embodiment, during hydrolysis, mixture M1 is mixed, for example it is stirred.

The hydrolysis reactor may be a batch reactor, which is optionally stirred.

Prior to pressurization b), the treatment method may optionally comprise a grinding step, preferably mechanical grinding.

When present, the step of grinding mixture M1 may be carried out before, during or after hydrolysis. In the latter case, grinding is then carried out on mixture M1h.

When the method of the invention carries out a hydrolysis step combined with a grinding step, then the method of the invention may optionally comprise a step of recirculating at least one fraction of the ground hydrolysate at the start of the hydrolysis step.

According to one embodiment, the hydrolysis reactor(s) comprise(s) a recirculation loop equipped with a grinding device, allowing at least one fraction of the hydrolysate to be introduced into said grinding device and at least one fraction, preferably all, of the hydrolysate thus ground to be returned to the start of the hydrolysis step.

The purpose of this grinding step is to reduce the particle size of mixture M1, typically so that the particle size of the solid fraction is less than 1000 μm, preferably less than 500 μm and more preferably less than 100 μm.

A particle size “less than X μm” means that 95% of solid particles are retained on a sieve with a square mesh size of X μm and that the remaining 5% are no larger than 3 times X μm.

In addition to the reduction in particle size, which minimizes downstream clogging, the grinding step homogenizes mixture M1 and reduces the viscosity thus allowing much better control of the process parameters for hydrothermal gasification.

Like the hydrolysis step, grinding and particle size reduction also contribute to biomass homogenization.

In high-pressure reactors, it is difficult to achieve mechanical stirring, and the viscosity reduction achieved by virtue of the hydrolysis step and/or the grinding step further improves internal turbulence and therefore homogenization in pressurized reactors.

### Pressurization Step b)

The method according to the invention comprises a step of pressurizing mixture M1h to a pressure ranging from 150 to 300 bar, preferably from 170 to 250 bar.

For the pressurization step, a pump may be provided on the line at the outlet of the hydrolysis reactor.

In another embodiment, a dedicated pump supplies the pressurization pump.

### Heating Step c)

The method according to the invention comprises a step of heating mixture M1h from step b) to a temperature ranging from 200 to 400 °C, preferably ranging from 240 to 350 °C.

The heating step can be carried out in a heat exchanger, for example by heat exchange using the stream from step g) of the method as the heating fluid. The stream from step g) of the method typically comprises water and gas.

Thus, a heat exchanger may be present downstream of the pressurization pump, said heat exchanger being configured to recover heat from the stream from step g) and to heat mixture M1h prior to separation step d).

The heated mixture at the end of step c) is referred to as mixture M2.

According to one embodiment, at least one additive is added to the stream of mixture M2, preferably after the heating device in step c) and before the first separation device in step d).

According to this embodiment, the additive(s) is (are) selected from oxidizing agents or alkaline reagents. Oxidizing agents include liquefied oxygen, hydrogen peroxide, air or permanganate salts such as potassium permanganate. Examples of alkaline reagents include KOH, NaOH, KHCO3, K2CO3, CaO, Ca(OH)2, CaCO3, Ca(HCO3)2, Mg(OH)2, MgO.

### First Separation Step d)

The method according to the invention comprises a first step of separating mixture M2 from step c), in order to obtain a first stream enriched in inorganic matter M3 and a first stream depleted of inorganic matter M4.

For the purposes of this invention, “stream enriched in inorganic matter” means a stream comprising a mass proportion of inorganic matter greater than the mass proportion of inorganic matter in mixture M2.

For the purposes of the present invention, “stream depleted of inorganic matter” means a stream comprising a mass proportion of inorganic matter lower than the mass proportion of inorganic matter in mixture M2.

According to one embodiment, the ratio between the concentration of inorganic matter in the enriched stream M3 and the concentration of inorganic matter in mixture M2 is at least 2, preferably at least 5.

The first separation step is typically carried out in a separation device comprising a feed line for mixture M2 from step c) and two outlet lines: (i) a line for extracting the first stream enriched in inorganic matter M3 and (ii) a line for extracting the first stream depleted of inorganic matter M4.

The first separation device may be a gravitational or hydraulic cyclone-type separation device typically fitted at the bottom with a continuous or intermittent discharge system.

According to one embodiment, at least one additive is added to the stream enriched in inorganic matter M3 from step d). According to one embodiment, said additive is added to stream M3 in a recovery reactor located downstream of the first separation device.

Preferably, said additive is selected from oxidizing agents such as liquefied oxygen, hydrogen peroxide, air, permanganate salts such as for example potassium permanganate, or from magnesium salts such as for example magnesium hydroxide (Mg(OH)2), magnesium oxide (MgO) or magnesium chloride (MgCl2) or from alkaline reagents such as for example KOH, NaOH, KHCO3, K2CO3, CaO, Ca(OH)2, CaCO3, Ca(HCO3)2, Mg(OH)2, MgO, or from ammonia solutions such as ammonium hydroxide or ammonium chloride or from a mixture of these reagents.

According to one embodiment, the additive is an ammonia solution from the liquid effluent M10 obtained after cooling and expansion of stream M8 from hydrothermal gasification (step g) of the method of the invention).

When struvite is to be formed, the additive added to stream M3 is preferably a magnesium salt, optionally mixed with an ammonia solution.

According to one embodiment, if stream M3 comprises at least 50% by dry weight of silica with respect to the total dry weight of the first stream M3, then preferably the method will comprise a step of adding an additive selected from oxidizing agents.

When a recovery device is used, then it is possible to allow a residence time making it possible then to precipitate the salts targeted by the addition of said additive.

According to one embodiment, mixture M1 comprises silica. According to this embodiment, the first stream enriched in inorganic matter M3 from step d) comprises silica, preferably in a proportion ranging from 10 to 70% by dry weight, with respect to the total dry weight of the first stream enriched in inorganic matter M3.

### Optional Pressurization Step

According to one embodiment, the treatment method according to the invention comprises a second pressurization step carried out on the first stream depleted of inorganic matter M4 from step d), upstream of step e). The stream resulting from this pressurization step is called stream M4′.

According to this embodiment, preferably, the first pressurization step brings the hydrolyzed mixture M1h to a pressure ranging from 150 to 220 bar and the second pressurization step brings the first stream depleted of inorganic matter M4 from step d) to a pressure greater than or equal to 225 bar.

The hydrothermal gasification processes of the state of the art operate with a single operating pressure. According to an advantageous embodiment of the invention, the method of the invention implements two operating pressures. This two-pressure operation offers multiple advantages.

On the one hand, only one fraction of the installation is highly pressurized (only the “second part”, after the second pressurization), therefore construction costs and installation constraints are reduced.

On the other hand, at the moment of heat exchange, the temperature at which there is a substantial change in energy with a small temperature delta (delta T) is not carried out at the same time. This results in a higher delta T which is the force of heat the exchange in the exchanger and therefore a smaller exchanger.

The second pressurization step allows heating step e) to be carried out with lower energy consumption.

### Heating Step e)

The method according to the invention comprises a heating step carried out on the first stream depleted of inorganic matter M4, preferably at a temperature greater than or equal to 300 °C and less than 600 °C.

When a second pressurization step is carried out, said heating step e) is carried out on stream M4′ depleted of inorganic matter from the second pressurization step.

When the method comprises the second pressurization step, then preferably heating step e) heats the first stream depleted of inorganic matter M4′ to a temperature greater than or equal to 400 °C and less than 600 °C.

Heating step e) can be carried out in a heating device selected from electric heating or indirect heating by hot combustion gases.

### Second Separation Step f)

The method according to the invention comprises a second separation step carried out on the first stream depleted of inorganic matter M4 from heating step e) in order to obtain a second stream enriched in inorganic matter M5 and a second stream depleted of inorganic matter M6.

When a second pressurization step is carried out, then the second separation step f) is carried out on the first stream M4′ depleted of inorganic matter from heating step e) in order to obtain a second stream enriched in inorganic matter M5 and a second stream depleted of inorganic matter M6.

According to one embodiment, the ratio between the concentration of inorganic matter in the enriched stream M5 and the concentration of inorganic matter in stream M4 is at least 2, preferably at least 5.

The second separation step is typically carried out in a separation device comprising a feed line for mixture M4 (or M4′ if a second pressurization is present) from step e) and two outlet lines: (i) a line for extracting the second stream enriched in inorganic matter M5 and (ii) a line for extracting the second stream depleted of inorganic matter M6.

The second separation device may be a gravitational or hydraulic cyclone-type separation device typically fitted at the bottom with a continuous or intermittent discharge system.

According to one embodiment, at least one additive is added to the second stream enriched in inorganic matter M5 from step f). According to one embodiment, said additive is added to stream M5 in a recovery reactor located downstream of the second separation device.

Preferably, said additive is selected from oxidizing agents such as liquefied oxygen, hydrogen peroxide, air, permanganate salts such as for example potassium permanganate, or from magnesium salts such as for example magnesium hydroxide (Mg(OH)2), magnesium oxide (MgO) or magnesium chloride (MgCl2) or from alkaline reagents such as for example KOH, NaOH, KHCO3, K2CO3, CaO, Ca(OH)2, CaCO3, Ca(HCO3)2, Mg(OH)2, MgO, or from ammonia solutions such as ammonium hydroxide or ammonium chloride or from a mixture of these reagents.

When a first additive is added to stream M3 and when a second additive is added to stream M5, then preferably the first additive is different from the second additive.

According to one embodiment, the additive is an ammonia solution from the liquid effluent M10 obtained after cooling and expansion of stream M8 from hydrothermal gasification (step g) of the method of the invention).

When struvite is to be formed, the additive added to stream M5 is preferably a magnesium salt, optionally mixed with an ammonia solution.

When a recovery device is used, then it is possible to allow a residence time making it possible then to precipitate the salts targeted by the addition of said additive.

According to one embodiment, mixture M1 comprises phosphorus and the second stream enriched in inorganic matter M5 from step f) comprises at least 70% by weight of the total weight of phosphorus present in mixture M1. In other words, at least 70% by weight of the phosphorus present in mixture M1 is recovered in the stream enriched in inorganic matter M5 from step f).

According to one embodiment, mixture M1 comprises phosphorus and the second stream enriched in inorganic matter M5 from step f) comprises phosphorus, preferably in a proportion ranging from 1 to 20% by weight, with respect to the total dry weight of the stream enriched in inorganic matter M5 from step f).

According to one embodiment, the method according to the invention further comprises at least one step of recovering at least one fraction of the inorganic matter in the form of salts, said recovery step being carried out on at least one stream selected from:
the first stream enriched in inorganic matter M3 and
the second stream enriched in inorganic matter M5.

Said recovery step may optionally comprise a step of adding at least one additive.

According to one embodiment of the method, at least a first additive is added to the stream of organic matter M1h upstream of step d) and at least a second additive is added to the first stream enriched in inorganic matter M3 from step d), the first additive preferably being different from the second additive.

Preferably, said additives are selected from oxidizing agents such as liquefied oxygen, hydrogen peroxide, air, permanganate salts such as for example potassium permanganate, or from magnesium salts such as for example magnesium hydroxide (Mg(OH)2), magnesium oxide (MgO) or magnesium chloride (MgCl2) or from alkaline reagents such as for example KOH, NaOH, KHCO3, K2CO3, CaO, Ca(OH)2, CaCO3, Ca(HCO3)2, Mg(OH)2, MgO, or from ammonia solutions such as ammonium hydroxide or ammonium chloride or from a mixture of these reagents.

According to one embodiment, the additive is an ammonia solution from the liquid effluent M10 obtained after cooling and expansion of stream M8 from hydrothermal gasification (step g) of the method of the invention).

According to an embodiment of the method, at least a first additive is added to the stream of organic matter M1h upstream of step d), at least a second additive is added to the first stream enriched in inorganic matter M3 from step d), and at least a third additive is added to the second stream enriched in inorganic matter M5 from step f), the first additive preferably being different from the second additive and the third additive, the second additive preferably being different from the third additive.

Preferably, said additives are selected from oxidizing agents such as liquefied oxygen, hydrogen peroxide, air, permanganate salts such as for example potassium permanganate, or from magnesium salts such as for example magnesium hydroxide (Mg(OH)2), magnesium oxide (MgO) or magnesium chloride (MgCl2) or from alkaline reagents such as for example KOH, NaOH, KHCO3, K2CO3, CaO, Ca(OH)2, CaCO3, Ca(HCO3)2, Mg(OH)2, MgO, or from ammonia solutions such as ammonium hydroxide or ammonium chloride or from a mixture of these reagents.

According to one embodiment, the additive is an ammonia solution from the liquid effluent M10 obtained after cooling and expansion of stream M8 from hydrothermal gasification (step g) of the method of the invention).

### Hydrothermal Gasification Step g)

The treatment method according to the invention comprises a hydrothermal gasification step g).

Hydrothermal gasification (HG) is a thermal depolymerization process used to convert organic matter present in a humid environment into a mixture comprising only small molecules under high to moderate temperature and pressure.

During the HG process, the carbon and hydrogen in an organic matter are converted thermochemically under near-critical or supercritical conditions. Part is converted into water-soluble compounds with low molar masses.

Another part is converted into gaseous products such as carbon dioxide (CO2), methane (CH4), dihydrogen (H2), carbon monoxide (CO), light hydrocarbons such as ethane (C2H6) and propane (C3H8).

During residence in the hydrothermal gasification reactor at temperatures less than 400 °C, the organic matter undergoes, among other reactions, hydrolysis-based decomposition, similar to the reactions occurring in the liquefaction process, but much more rapidly. In fact, implementation under near-critical or supercritical conditions makes it possible to use the unique properties of supercritical water as a solvent, allowing homogeneous solvation and reaction conditions, leading to very high reaction kinetic speeds. As a result, a much shorter residence time and a much higher heating rate than in conventional hydrolysis are used, limiting or even avoiding the secondary condensation and polymerization reactions responsible for bio-oil and bio-char formation.

When the HG operates at temperatures above 400 °C, radical decomposition of polymers (involving in particular decarboxylation, deamination reactions by breaking C—N bonds, and C—C or C—O cleavage) predominates, while endothermic steam reforming is the main reaction pathway for converting small molecules with 1 to 3 carbon atoms into carbon oxides and dihydrogen, and nitrogen into ammonia.

Methane is also produced by the methanation of CO and CO2, using dihydrogen.

As a result, HG can be seen as a decomposition process transforming the organic residues present in stream M4 into a more readily biodegradable material and into ammonia dissolved in the liquid phase.

The treatment conditions (in particular temperature, pressure, and to a lesser extent residence time) of the HG can be adjusted to not only produce a gaseous fraction containing CH4, CO, CO2 and H2 (synthesis gas), but also to produce an aqueous effluent, containing mainly easily digestible compounds, notably carboxylic acids, on the one hand, and ammonia in the form of the ammonium salt of the carbonic acids produced, on the other hand.

It should be noted that HG is different from hydrothermal liquefaction (HTL), in particular in that the conversion rate and level of decomposition of organic matter in HTL are not as high as in HG, even when HG is operated under moderate temperature conditions.

Under HTL conditions, the water still contains HO− and H3O+ ions which initiate the hydrolysis of organic matter.

Hydrolysis only takes place on the surface of the cellulose compounds contained in the organic fraction which dissolves very little in the subcritical medium, resulting in fairly low decomposition conversions.

Condensation reactions (comprising mainly Aldol condensation, alkylation or Friedel-Craft acylation) of intermediates are an important reaction pathway, leading to the formation of biocrude which is an oil (also called bio-oil) that can be used as a fuel, that is, biocrude contains organic molecules containing 5 or more carbon atoms, generally from 8 to 16 carbon atoms. The liquid product of HG, on the other hand, contains mainly readily biodegradable compounds.

HG differs from pyrolysis in that it is carried out in a medium containing water, the water being in a supercritical or near-critical state.

HG differs from “conventional” gasification of organic matter in that “conventional” gasification reduces the carbon/hydrogen (C/H) mass ratio, resulting in products with increased calorific value, including a gas composed mainly of synthesis gas (H2/CO mixture), bio-oil and/or carbonaceous solid (char).

In the treatment method according to the invention, the hydrothermal gasification step is typically implemented in a hydrothermal gasification reactor, supplied at the inlet by the second stream depleted of inorganic matter M6 and comprising at least one outlet for stream M8 comprising gas and a liquid effluent, and optionally at least a second outlet for a stream M7 enriched in inorganic matter.

Stream M7 enriched in inorganic matter comprises a higher inorganic content than the inorganic content of stream M6. Preferably, the mass ratio between the inorganic content in stream M7 and the inorganic content in stream M6 is greater than or equal to 2, preferably greater than or equal to 5.

Streams M7 and M8 can be separated by gravitational precipitation of stream M7.

According to one embodiment, the gasification reactor is a tubular reactor.

Preferably, the hydrothermal gasification step is carried out at a temperature less than 600 °C, preferably ranging from 350 °C to less than 600 °C, even more preferably ranging from 450 to less than 600 °C.

Preferably, the hydrothermal gasification step is carried out at a pressure greater than or equal to 220 bar, preferably greater than or equal to 250 bar.

Preferably, the (overall) residence time of the stream depleted of inorganic matter M6 in HG step g) typically ranges from 1 min to 20 min, preferably from 2 min to 10 min, more preferentially from 3 to 5 min.

According to one embodiment, the hydrothermal gasification step is carried out in the presence of a catalyst. Preferably, the catalyst is selected from metals on activated carbon, such as ruthenium, nickel, palladium or platinum.

The catalyst can be in the form of a bed of solid particles within the gasification reactor.

By virtue of the separation steps d) and f) of the method of the invention which allow so-called “poisonous” compounds to be removed, any catalyst used in the hydrothermal gasification step is not damaged by these harmful compounds which can damage or notably deactivate the catalyst.

In the context of the present invention, the hydrothermal gasification step makes it possible to obtain at least one stream M8 comprising a mixture of gases dissolved in a liquid effluent.

According to one embodiment, the hydrothermal gasification step also makes it possible to obtain a stream enriched in inorganic matter M7. According to this embodiment, preferably, at least one additive is added to stream M7.

Preferably, said additive is selected from oxidizing agents such as liquefied oxygen, hydrogen peroxide, air, permanganate salts such as for example potassium permanganate, or from magnesium salts such as for example magnesium hydroxide (Mg(OH)2), magnesium oxide (MgO) or magnesium chloride (MgCl2) or from alkaline reagents such as for example KOH, NaOH, KHCO3, K2CO3, CaO, Ca(OH)2, CaCO3, Ca(HCO3)2, Mg(OH)2, MgO, or from ammonia solutions such as ammonium hydroxide or ammonium chloride or from a mixture of these reagents.

According to one embodiment, the method further comprises a step of recovering inorganic matter, preferably a step of recovering salts, carried out on at least one fraction of stream M7 from the hydrothermal gasification step.

According to one embodiment, stream M8 from step g) is cooled to a temperature less than or equal to 100 °C, preferably less than or equal to 60 °C, before any digestion step. Said cooling step is preferably carried out by heat exchange with a stream of matter upstream of step g), preferably upstream of the first separation step.

According to one embodiment, the heat present in stream M8 from step g) is recovered, said recovered heat preferably allowing mixture M1h to be at least partially heated during step c).

Preferably, this heat recovery is carried out by heat exchange between the gas from step g) and mixture M1h.

Cooling can be carried out using a cooling device selected from heat exchangers, flash, scrubbers and Rankine cycles.

According to one embodiment, stream M8 is expanded in an expansion device up to a pressure ranging from 1 to 2 bar. This expansion step recovers, on the one hand, the gases produced during step g) (stream M9) and, on the other hand, a liquid effluent (stream M10). According to this embodiment, at least one fraction of the liquid effluent M10 from the expansion process can be used to supply a digestion device.

### Optional Digestion Step(s)

According to one embodiment, the treatment method according to the invention comprises at least one digestion step carried out on at least one fraction of the liquid effluent M10 obtained by cooling and expanding stream M8 from the hydrothermal gasification step g).

According to one embodiment, the treatment method according to the invention comprises at least one anaerobic digestion step carried out on the previously expanded liquid effluent from the hydrothermal gasification step g).

Anaerobic digestion may be mesophilic or thermophilic.

When mesophilic digestion is used, the temperature in the digester ranges from 33 °C to 37 °C and the residence time is 16 to 22 days.

When thermophilic digestion is used, the temperature in the digester ranges from 55 °C to 60 °C and the residence time is 10 to 12 days.

Residence time and temperature are two factors influencing the proper degradation of sludge and therefore the optimization of energy production.

At the end of the digestion step, a biogas is obtained.

This biogas typically comprises a mixture substantially consisting of methane, carbon dioxide and water. The biogas may optionally comprise other gases, such as hydrogen, oxygen, nitrogen, hydrogen sulfide, but these other gases collectively represent less than 10% by weight of the biogas, of the total weight of the biogas.

According to one embodiment, the treatment method according to the invention comprises:
a. a step of hydrolyzing mixture M1 at a temperature ranging from 70 to 165 °C and at a pressure ranging from 2 to 8 bar making it possible to obtain a hydrolyzed mixture M1h,
b. pressurizing at least one fraction of the hydrolyzed mixture M1h, preferably all of the hydrolyzed mixture M1h, bringing the hydrolyzed mixture M1h to a pressure ranging from 150 to 250 bar,
c. a step of heating mixture M1h from step b) in order to obtain a mixture M2 having a temperature ranging from 200 to 350 degrees,
d. a first step of separating mixture M2 from step c) in order to obtain a first stream enriched in inorganic matter M3 and a first stream depleted of inorganic matter M4,
a second pressurization step carried out on the first stream depleted of inorganic matter M4 from step d) in order to obtain stream M4′,
e. a heating step carried out on at least one fraction of stream M4′, preferably on all of M4′, at a temperature of at least 300 °C and less than 600 °C,
f. a second separation step carried out on at least one fraction of stream M4′ from step e) in order to obtain a second stream enriched in inorganic matter M5 and a second stream depleted of inorganic matter M6,
g. a hydrothermal gasification step carried out on at least one fraction of the second stream depleted of inorganic matter M6, preferably on all of the second stream M6 depleted of inorganic matter, in order to obtain at least one stream M8 comprising gas and a liquid effluent, said gasification step preferably being carried out at a temperature less than 600 °C,
the hydrothermal gasification step can optionally obtain, in addition to stream M8, a stream M7 enriched in inorganic matter, said stream M7 obtainable by separation producing stream M7 on the one hand and stream M8 on the other hand.

According to one embodiment, the treatment method according to the invention comprises:
a. a step of hydrolyzing mixture M1 at a temperature ranging from 70 to 165 °C and at a pressure ranging from 2 to 8 bar making it possible to obtain a hydrolyzed mixture M1h,
b. pressurizing at least one fraction of the hydrolyzed mixture M1h, preferably all of the hydrolyzed mixture M1h, bringing the hydrolyzed mixture M1h to a pressure ranging from 150 to 250 bar,
c. a step of heating mixture M1h from step b) in order to obtain a mixture M2 having a temperature ranging from 200 to 350 degrees,
d. a first step of separating mixture M2 from step c) in order to obtain a first stream enriched in inorganic matter M3 and a first stream depleted of inorganic matter M4,
a second pressurization step carried out on the first stream depleted of inorganic matter M4 from step d) in order to obtain stream M4′,
e. a heating step carried out on at least one fraction of stream M4′, preferably on all of M4′, at a temperature of at least 300 °C and less than 600 °C,
f. a second separation step carried out on at least one fraction of stream M4′ from step e) in order to obtain a second stream enriched in inorganic matter M5 and a second stream depleted of inorganic matter M6,
g. a hydrothermal gasification step carried out on at least one fraction of the second stream depleted of inorganic matter M6, preferably on all of the second stream M6 depleted of inorganic matter, in order to obtain at least one stream M8 comprising gas and a liquid effluent, and optionally a stream M7 enriched in inorganic matter, said gasification step preferably being carried out at a temperature less than 600 °C,
said method further comprising:
a step of adding a first additive to stream M3, and
a step of adding a second additive to stream M5, and
optionally a step of adding a third additive to stream M7,
preferably, the three additives are different.

The invention also relates to an installation for implementing the treatment method according to the invention.

The installation according to the invention comprises:
at least one hydrolysis reactor 1 optionally comprising a stirring device, supplied at the inlet by a feed line for mixture M1 to be treated and comprising an outlet line for the hydrolyzed mixture,
optionally, a mechanical grinding device supplied by the outlet line for the hydrolyzed mixture and comprising an outlet line for the hydrolyzed and ground mixture,
a pressurization pump 3 supplied by the hydrolyzed mixture, which is optionally ground,
a heating device 4 comprising an inlet for introducing at least one fraction of the pressurized mixture downstream of the pump 3,
a first separation device 51 supplied by at least one fraction of the heated mixture from the heating device 4 and comprising an outlet for a stream M3 enriched in inorganic matter and an outlet for a stream M4 depleted of inorganic matter,
optionally, a pressurization pump (61) supplied by at least one fraction of stream M4 depleted of inorganic matter, making it possible to obtain stream M4′,
a heating device 6 supplied by stream M4 depleted of inorganic matter from the separation device 51 or by stream M4′ depleted of inorganic matter from the pressurization pump 61 when it is present,
a second separation device 71 supplied by at least one fraction of the heated mixture from the heating device 6 and comprising an outlet for a stream M5 enriched in inorganic matter and an outlet for a stream M6 depleted of inorganic matter,
a hydrothermal gasification reactor 8 supplied by at least one fraction of stream M6 depleted of inorganic matter.

Thus, the installation according to the invention may comprise one or more hydrolysis reactors 1 in series or in parallel, supplied at the inlet by a feed line for mixture M1 and an outlet line for the hydrolyzed mixture M1h at a temperature less than or equal to the hydrolysis temperature. The hydrolysis reactor(s) 1 advantageously comprise(s) a heating and pressurization device and optionally comprise(s) a stirring device, as well as advantageously an internal heat recovery device.

The installation may optionally further comprise one or more elements selected from:
a heat exchanger 9 for recovering the heat present in stream M8 from the hydrothermal gasification reactor 8, and/or
an expansion device 10 supplied by stream M8 from hydrothermal gasification and comprising an outlet for a liquid effluent, and/or
a digestion device 11 supplied by at least one fraction of the liquid effluent from expansion 10.

Preferably, if the installation comprises a heat exchanger 9 and an expansion device 10, then the expansion device 10 is located downstream of the heat exchanger 9.

According to one embodiment of the installation, the heating device 4 is a heat exchanger configured to recover heat from stream M8 downstream of the gasification reactor.

The installation according to the invention may optionally comprise both a heat exchanger-type heating device 4 configured to recover heat from stream M8 downstream of the gasification reactor and a (further) heat exchanger 9 making it possible to further cool stream M8.

The installation may optionally comprise a device for recovering inorganic matter, in particular for recovering salts. According to this embodiment, the system according to the invention preferably comprises at least one additive injection device.

Preferably, the installation comprises at least one device for injecting additives into at least one of the following streams:
the stream of mixture M1 upstream of the hydrolysis device 1,
the stream of mixture M1h downstream of the hydrolysis device and upstream of the heating device 4,
the stream of mixture M2 downstream of the heating device 4 (upstream of the separation device 51),
the first stream enriched in inorganic matter M3 downstream of the separation device 51,
the second stream enriched in inorganic matter M5 downstream of the second separation device 71,
any stream M7 enriched in inorganic matter from the hydrothermal gasification reactor.

The method and the installation according to the invention allows a mixture comprising organic matter and inorganic matter to be treated, in order to recover the matter with optimum yield and selectivity.

The nature of the additive(s) is selected specifically based on the salts to be recovered, these salts themselves being determined based on the quality and type of mixture M1 used in the method.

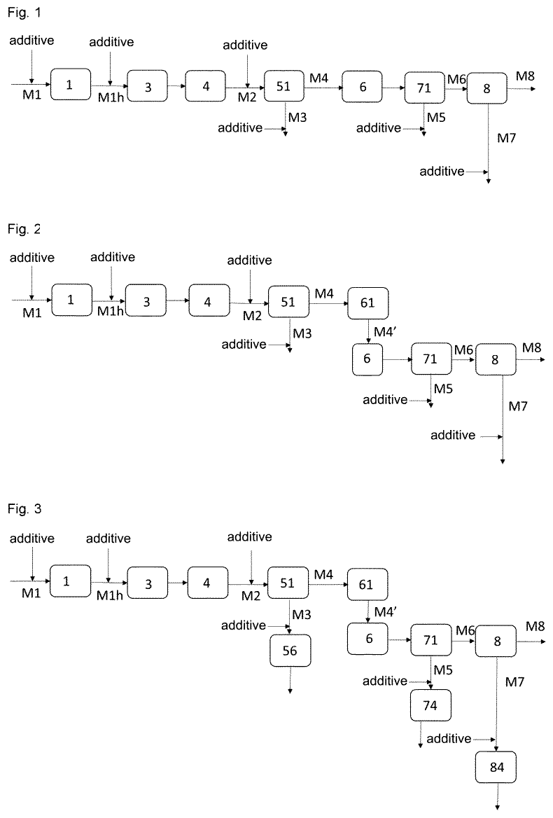

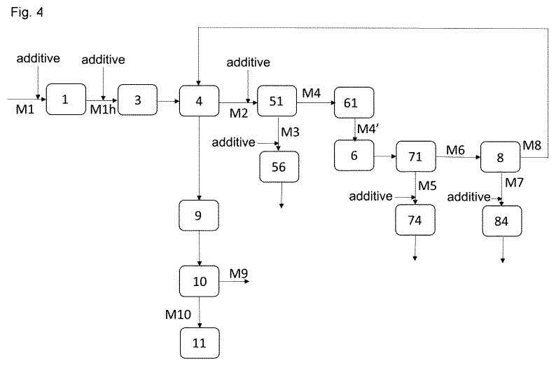

FIG. 1, FIG. 2, FIG. 3 and FIG. 4 each show an installation according to the invention, without limiting the scope thereof.

The figures show different injection points for at least one additive, it being understood that the installation according to the invention may comprise one or more injection points. Preferably several injection points are present, in particular at least one injection point upstream of the first separation device 51 and at least one injection point in the line of stream M3, and at least one injection point in the line of stream M5 and at least one injection point in the line of stream M7.

As shown in the diagram of FIG. 1, in the context of the invention, mixture M1 comprising organic matter and inorganic matter, for example of the biomass or sewage sludge type, optionally containing an additive, is introduced into a hydrolysis reactor 1 comprising an inlet for introducing mixture M1 and an outlet for discharging the hydrolyzed mixture M1h.

The hydrolysis reactor(s) 1 may optionally be preceded by a grinding device or may be provided with a recirculation loop equipped with a grinding device or may be followed by a grinding device, upstream of the pressurization pump 3.

In the context of the invention, the hydrolyzed mixture M1h, pressurized by virtue of the pressurization pump 3, is then introduced into a heating device 4. The heating device 4 typically brings the mixture to a temperature ranging from 200 to 400 °C, preferably from 240 to 350 °C (mixture called M2).

In the context of the invention, mixture M2 is then introduced into a separation device 51 in order to obtain a first stream enriched in inorganic matter M3 and a first stream depleted of inorganic matter M4. Upstream of the separation device 51, an additive may be added to the stream of mixture M2 in order to promote separation.

In accordance with the invention shown in FIG. 1, the first stream depleted of inorganic matter M4 is then introduced into a heating device 6 making it possible to heat stream M4, preferably to a temperature greater than or equal to 300 °C and less than 600 °C.

In the context of the invention shown in FIG. 1, the heated mixture leaving the heating device 6 is then introduced into a second separation device 71 making it possible to obtain a second stream enriched in inorganic matter M5 and a second stream depleted of inorganic matter M6.

In the invention shown in FIG. 1, the second stream depleted of inorganic matter M6 is then introduced into a hydrothermal gasification reactor 8.

In the context of the invention shown in FIG. 1, an additive may optionally be added to the first stream enriched in inorganic matter M3 and/or to the second stream enriched in inorganic matter M5 and/or to the stream M7 enriched in inorganic matter exiting hydrothermal gasification.

FIG. 2 shows an embodiment of an installation and a method according to the invention which differs from the embodiment of FIG. 1 in that it includes a second pressurization step.

In the context of the invention shown in FIG. 2, the first stream depleted of inorganic matter M4 leaving the first separation device 51 is then pressurized by virtue of a pressurization pump 61 making it possible to obtain a stream M4′ which is then introduced into the heating device 6.

According to the embodiment shown in FIG. 2, preferably the pressurization pump 3 is used to pressurize the hydrolyzed mixture M1h to a pressure ranging from 150 to 220 bar and the pressurization device 61 is used to pressurize stream M4 to a pressure greater than or equal to 225 bar.

FIG. 3 shows an embodiment of an installation and a method according to the invention which differs from the embodiment of FIG. 2 due to the presence of recovery reactors 56, 74 and 84.

According to one embodiment shown in FIG. 3, the installation comprises a recovery device 56 downstream of the first separation device 51, supplied by stream M3, optionally mixed with an additive. It should be noted that in the context of the invention, additives may be added directly to the recovery device 56 (and not to stream M3 as shown in FIG. 3).

According to one embodiment shown in FIG. 3, the installation comprises a recovery device 74 downstream of the second separation device 71, supplied by stream M5, optionally mixed with an additive. It should be noted that in the context of the invention, additives may be added directly to the recovery device 74 (and not to stream M5 as shown in FIG. 3).

According to one embodiment shown in FIG. 3, the installation comprises a recovery device 84 downstream of the hydrothermal gasification reactor, supplied by stream M7, optionally mixed with an additive. It should be noted that in the context of the invention, additives may be added directly to the recovery device 84 (and not to stream M7 as shown in FIG. 3).

FIG. 4 shows an embodiment of an installation and a method according to the invention, which differs from the embodiment shown in FIG. 3 due to the presence of a heat recovery loop for recovering the heat present in stream M8, which consists of a mixture of gases dissolved in a liquid effluent from the hydrothermal gasification reactor 8.

According to one embodiment shown in FIG. 4, the stream M8 from the hydrothermal gasification reactor 8 is cooled by heat exchange with the heating device 4 and supplies a cooling device 9 (preferably by heat recovery).

According to one embodiment shown in FIG. 4, the stream leaving the heat recovery device 9 is then expanded in an expansion device 10 in order to obtain a stream of gas M9 and a liquid stream M10.

According to one embodiment, the liquid stream M10 supplies a digester 11.

The installation according to the invention may of course comprise one or more of the features described as part of the method according to the invention.

1. A method for treating a mixture M1 comprising at least organic matter, the method comprising:
a) hydrolyzing the mixture M1 at a temperature ranging from 70 to 165 °C and at a pressure ranging from 2 to 8 bar to obtain a hydrolyzed mixture M1h,
b) pressurizing at least one fraction of the hydrolyzed mixture M1h,
c) heating mixture M1h from step b) to obtain a mixture M2,
d) separating at least one fraction of the mixture M2 from step c) to obtain a first stream enriched in inorganic matter M3 and a first stream depleted of inorganic matter M4,
e) heating at least one fraction of the first stream depleted of inorganic matter M4,
f) separating at least one fraction of the first stream depleted of inorganic matter M4 from step e) to obtain a second stream enriched in inorganic matter M5 and a second stream depleted of inorganic matter M6,
g) carrying out hydrothermal gasification on at least one fraction of the second stream M6 depleted in inorganic matter to obtain at least one stream M8 comprising gas and a liquid effluent.

2. The method according to claim 1, wherein the pressurization step b) raises the pressure of the hydrolyzed mixture M1h to a pressure of 150 to 300 bar and/or the heating step c) heats mixture M1h resulting from step b) to a temperature ranging from 200 to 350 °C.

3. The method according to claim 1, wherein the heating step e) heats all or part of the first stream depleted of inorganic matter M4 at a temperature ranging from 300 °C to less than 600 °C.

4. The method according to claim 1, further comprising:
pressurizing the first stream depleted of inorganic matter M4 from step d), upstream of the heating in step e),
wherein the pressurization step b) pressurizes the hydrolyzed mixture M1h to a pressure ranging from 150 to 220 bar.

5. The method according to claim 4, wherein the first stream depleted of inorganic matter M4 from step d) is raised to a pressure greater than or equal to 225 bar to obtain a stream M4′, and heating step e) heats stream M4′ to a temperature ranging from 400 °C to less than 600 °C.

6. The method according to claim 1, wherein the gasification step g) comprises a separation step to obtain a stream M7 enriched in inorganic matter and stream M8.

7. The method according to claim 6, further comprising:
recovering at least one fraction of the inorganic matter in the form of salts, the recovery being carried out on at least one fraction of a stream selected from:
the first stream enriched in inorganic matter M3,
the second stream enriched in inorganic matter M5, and
the stream M7 enriched in inorganic matter.

8. The method according to claim 1, wherein mixture M1 comprises from 5 to 50% by weight of solids with respect to the total weight of mixture M1.

9. The method according to claim 1, wherein the first stream enriched in inorganic matter M3 from step d) comprises silica.

10. The method according to claim 1, wherein the second stream enriched in inorganic matter M5 from step f) comprises phosphorus.

11. The method according to claim 1, wherein at least one additive is added.

12. The method according to claim 11, wherein at least a first additive is added to the first stream enriched in inorganic matter M3 from step d) and at least a second additive is added to the second stream enriched in inorganic matter M5 from step f).

13. The method according to claim 1, further comprising a step of recovering heat present in stream M8 from the hydrothermal gasification.

14. The method according to claim 1, further comprising at least one digestion step carried out on at least one fraction of a liquid effluent M10 obtained by cooling and then expanding at least one fraction of stream M8 from step g).

15. An installation for implementing the method of claim 1, the installation comprising:
one or more hydrolysis reactor(s). supplied at an inlet by a feed line for mixture M1 to be treated and comprising an outlet line for the hydrolyzed mixture;
a pressurization pump supplied at the inlet by the hydrolyzed mixture, which is optionally ground;
a heating device comprising an inlet for introducing at least one fraction of the pressurized mixture downstream of the pump;
a first separation device supplied by at least one fraction of the heated mixture from the heating device and comprising an outlet for a stream M3 enriched in inorganic matter and an outlet for a stream M4 depleted of inorganic matter;
optionally, a pressurization pump supplied by at least one fraction of stream M4 depleted of inorganic matter, making it possible to obtain stream M4′;
a heating device supplied by stream M4 depleted of inorganic matter from the separation device or by stream M4′ depleted of inorganic matter from the pressurization pump when it is present;
a second separation device supplied by at least one fraction of the heated mixture from the heating device and comprising an outlet for a stream M5 enriched in inorganic matter and an outlet for a stream M6 depleted of inorganic matter; and
a hydrothermal gasification reactor supplied by at least one fraction of stream M6 depleted of inorganic matter.

16. The installation according to claim 15, wherein the one or more hydrolysis reactor(s) comprises a stirring device.

17. The installation according to claim 15, further comprising:
a mechanical grinding device supplied by the outlet line for the hydrolyzed mixture and comprising an outlet line for the hydrolyzed and ground mixture.

18. The method according to claim 6, wherein at least one additive is added to at least one fraction of a stream selected from:
the stream of mixture M1 upstream of step a),
the stream of mixture M1h upstream of step c),
the stream of mixture M2 from step c),
the first stream enriched in inorganic matter M3,
the second stream enriched in inorganic matter M5, and
the stream M7 enriched in inorganic matter.
